(19) United States
(12) Patent Application Publication
(10) Pub. No.: US 2026/0248297 A1
(43) Pub. Date: Aug. 27, 2026

(54) AIR MATTRESS

(71) Applicant: Paramount Bed Co., Ltd., Tokyo (JP)

(72) Inventors: Ryosuke YAHAGI, Koto-ku (JP); Hiroki MORIMOTO, Koto-ku (JP)

(73) Assignee: Paramount Bed Co., Ltd., Tokyo (JP)

(21) Appl. No.: 19/266,858

(22) Filed: Jul. 11, 2025

(30) Foreign Application Priority Data
Feb. 27, 2025 (JP) 2025-030453

(51) Int. Cl. A47C 27/10; A47C 27/08; A61G 7/00

(52) U.S. Cl. CPC A47C 27/10; A47C 27/083; A61G 7/001

(57) ABSTRACT

An air mattress includes: a main mattress that supports a body of a user; and a shoulder part mattress that is disposed below the main mattress. The shoulder part mattress includes a first air cell that is disposed on an outer side in a left-and-right direction, a second air cell that is disposed on a further inner side in the left-and-right direction than the first air cell, and a third air cell that is disposed on a further inner side in the left-and-right direction than the second air cell. A front end of the second air cell is disposed further rear than a front end of the first air cell. A front end of the third air cell is disposed further rear than the front end of the second air cell.

### CROSS-REFERENCE TO RELATED APPLICATIONS

This application is based upon and claims the benefit of priority from the prior Japanese Patent Application No.2025-030453, filed on February 27, 2025; the entire contents of which are incorporated herein by reference.

### FIELD

Embodiments of the present disclosure relate to an air mattress.

### BACKGROUND

An air mattress provided with air cells capable of changing a body position of a user has been known (JP2014-046042A).

### BRIEF DESCRIPTION OF THE DRAWINGS

FIG. 1 is a side view illustrating a motorized bed unit provided with an air mattress according to a first embodiment of the present disclosure.

FIG. 2 is a block diagram illustrating a control system of the motorized bed unit.

FIG. 3 is a block diagram illustrating a control system of the air mattress.

FIG. 4 is a diagram illustrating an air supply/exhaust system of a shoulder part mattress.

FIG. 5 is a diagram illustrating magnitude, position, and dimension relationships of the shoulder part mattress.

FIG. 6 is a cross-sectional diagram seen from an arrow A-A direction in FIG. 4 in a state where the shoulder part mattress fully inflates.

FIG. 7 is a diagram illustrating an inclined angle of the shoulder part mattress.

FIG. 8 is a flow diagram illustrating body stabilization control processing that is executed by a mattress controller.

FIG. 9 is a flow diagram illustrating body position change control processing that is executed by the mattress controller.

FIG. 10 is a diagram illustrating a state where the body position change control processing has been executed.

FIG. 11 is a plan view illustrating an air mattress according to a second embodiment of the present disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms "component," "system" and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term "article of manufacture" as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words "example" and "exemplary" are used herein to mean serving as an instance or illustration. Any embodiment or design described herein as "example" or "exemplary" is not necessarily to be construed as preferred or advantageous over other embodiments or designs. Rather, use of the word example or exemplary is intended to present concepts in a concrete fashion. As used in this application, the term "or" is intended to mean an inclusive "or" rather than an exclusive "or". That is, unless specified otherwise or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims should generally be construed to mean "one or more" unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is an air mattress including: a main mattress that supports a body of a user; and a shoulder part mattress that is disposed below the main mattress, in which the shoulder part mattress includes a first air cell that is disposed on an outer side in a left-and-right direction, a second air cell that is disposed on a further inner side in the left-and-right direction than the first air cell, and a third air cell that is disposed on a further inner side in the left-and-right direction than the second air cell, a front end of the second air cell is disposed further rear than a front end of the first air cell, and a front end of the third air cell is disposed further rear than the front end of the second air cell.

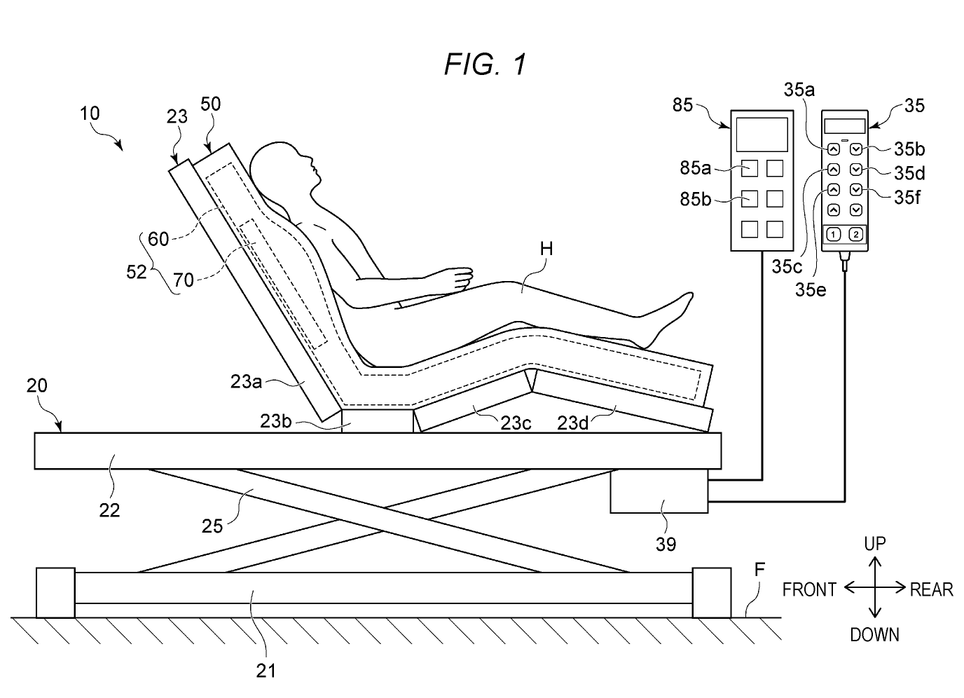

An air mattress according to embodiments of the present disclosure will be described with reference to FIGS. 1 to 11.

FIG. 1 is a side view illustrating a motorized bed unit provided with an air mattress according to a first embodiment of the present disclosure.

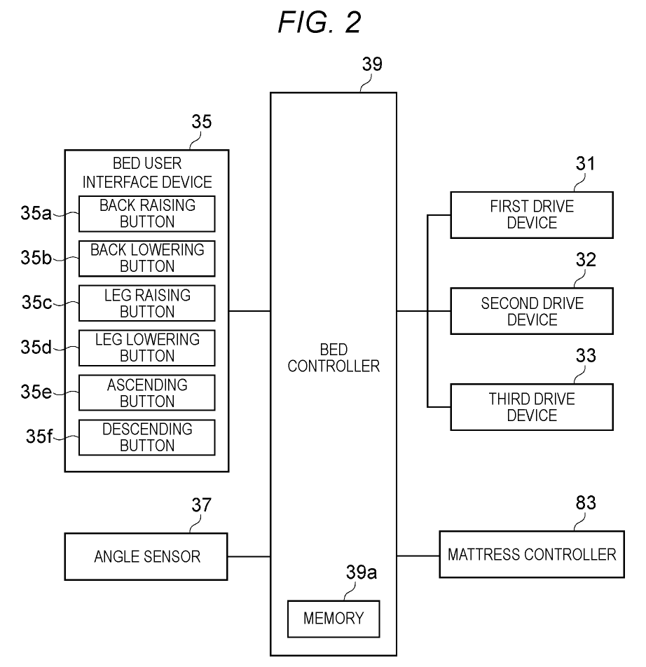

FIG. 2 is a block diagram illustrating a control system of the motorized bed unit.

A motorized bed unit 10 illustrated in FIG. 1 is used in a care facility, a hospital, and a home, for example, and is configured to be able to electrically raise and tilt a backrest, an upper leg part, and the like, and be able to electrically change the height of a bed 20. The motorized bed unit 10 illustrated in FIG. 1 is illustrated in a simplified manner, in which illustration of drive devices for raising and tilting the backrest, the upper leg part, and the like, and changing the height of the bed 20 is omitted. In the embodiment, description will be made by indicating a head side and a foot side of a user H lying on the bed 20 as a front side and a rear side, respectively, and description will be made by indicating a right hand side of the user H taking a supine position as a right side, and a left hand side of the user H as a left side. The motorized bed unit 10 is provided with the bed 20, and an air mattress 50 provided to the bed 20.

The bed 20 includes a base frame 21 that is placed on a floor surface F, main frames 22 that are disposed above the base frame 21, and sections 23 that can be raised and tilted relative to the main frames 22. The two main frames 22 are provided apart from each other in a left-and-right direction (lateral direction) of the bed 20, and extend in a front-and-rear direction. The base frame 21 supports the main frames 22 via a lifting mechanism 25, for example. The main frames 22 can move in the up-and-down direction relative to the base frame 21 by a third drive device 33, which is described later.

The sections 23 include an upper surface, which is a placed surface of a mattress 52. As illustrated in FIG. 1, the sections 23 support the user H via the mattress 52. The sections 23 include a back section 23a, a seat section 23b, an upper leg section 23c, and a lower leg section 23d.

The back section 23a supports the head part or the back of the user H lying on the bed 20. The back section 23a can be raised and tilted by a first drive device 31, which is described later. FIG. 1 illustrates a state where the back section 23a is raised. The seat section 23b is disposed on the rear side of the back section 23a. The seat section 23b supports the seat part or the buttocks of the user H lying on the bed 20.

The upper leg section 23c is disposed on the rear side of the seat section 23b. The upper leg section 23c supports the femoral region of the user H lying on the bed 20. The lower leg section 23d is disposed on the rear side of the upper leg section 23c. The lower leg section 23d supports the leg region of the user H lying on the bed 20. The upper leg section 23c and the lower leg section 23d can be raised and tilted by a second drive device 32, which is described later. FIG. 1 illustrates the state where the upper leg section 23c and the lower leg section 23d are bent.

Below the sections 23, a backrest mechanism that raises and tilts the back section 23a, an upper leg raising mechanism that raises and tilts the upper leg section 23c and the lower leg section 23d, the lifting mechanism 25 that lifts up and lowers down the main frames 22 and the sections 23, and a bed controller 39 that controls an actuation of each mechanism, are provided.

The drive devices each including an electric cylinder, for example, actuate the backrest mechanism, the upper leg raising mechanism, and the lifting mechanism 25, respectively. The backrest mechanism actuated by the first drive device 31 raises and tilts the back section 23a. The upper leg raising mechanism actuated by the second drive device 32 bends the upper leg section 23c and the lower leg section 23d into a mountain fold state. The lifting mechanism 25 actuated by the third drive device 33 lifts up and lowers down the main frames 22 and the sections 23. This adjusts the height of the bed 20 from the floor surface F to the sections 23.

A bed user interface device 35 serves as a remote controller for actuating the first drive device 31, the second drive device 32, and the third drive device 33. The bed user interface device 35 is connected to the bed controller 39 in a wired or wireless manner. The user H and a care giver can raise and tilt the back section 23a, the upper leg section 23c, and the lower leg section 23d, and change the height of the bed 20 from the floor surface F, by operating the bed user interface device 35.

The bed user interface device 35 includes, for example, a back raising button 35a, a back lowering button 35b, a leg raising button 35c, a leg lowering button 35d, an ascending button 35e, and a descending button 35f. The respective operation buttons may be a touch panel or the like. The bed user interface device 35 may include a display or the like that displays a state of the bed 20.

The back raising button 35a and the back lowering button 35b are for actuating the first drive device 31. The back raising button 35a is operated to extend a rod of the first drive device 31 for raising the back section 23a. The back lowering button 35b is operated to retract the rod of the first drive device 31 for lowering the back section 23a.

The leg raising button 35c and the leg lowering button 35d are for actuating the second drive device 32. The leg raising button 35c is operated to extend a rod of the second drive device 32 for raising the upper leg section 23c and the lower leg section 23d. The leg lowering button 35d is operated to retract the rod of the second drive device 32 for lowering the upper leg section 23c and the lower leg section 23d.

The ascending button 35e and the descending button 35f are for actuating the third drive device 33. The ascending button 35e is operated to extend a rod of the third drive device 33 for increasing the height of the sections 23. The descending button 35f is operated to retract the rod of the third drive device 33 for decreasing the height of the sections 23.

An angle sensor 37 detects an inclined angle of the back section 23a (back angle) with respect to the horizontal direction. The angle sensor 37 detects, for example, a raising/tilting angle of the back section 23a with respect to the seat section 23b. The angle sensor 37 transmits the detected detection result to the bed controller 39.

The bed controller 39 is provided below the sections 23, for example. The bed controller 39 is connected to the bed user interface device 35. The bed controller 39 controls actuations of the first to third drive devices 31 to 33 based on the operation of the bed user interface device 35.

The bed controller 39 includes a memory 39a. Programs for actuating the first to third drive devices 31 to 33 are stored in the memory 39a. The bed controller 39 actuates the first to third drive devices 31 to 33 based on a command signal transmitted from the bed user interface device 35.

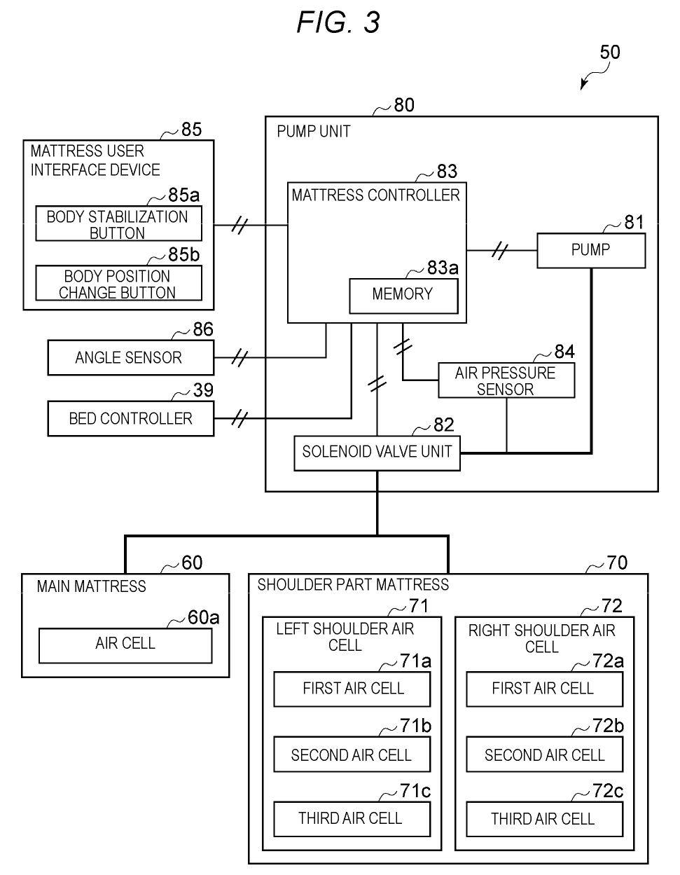

FIG. 3 is a block diagram illustrating a control system of the air mattress.

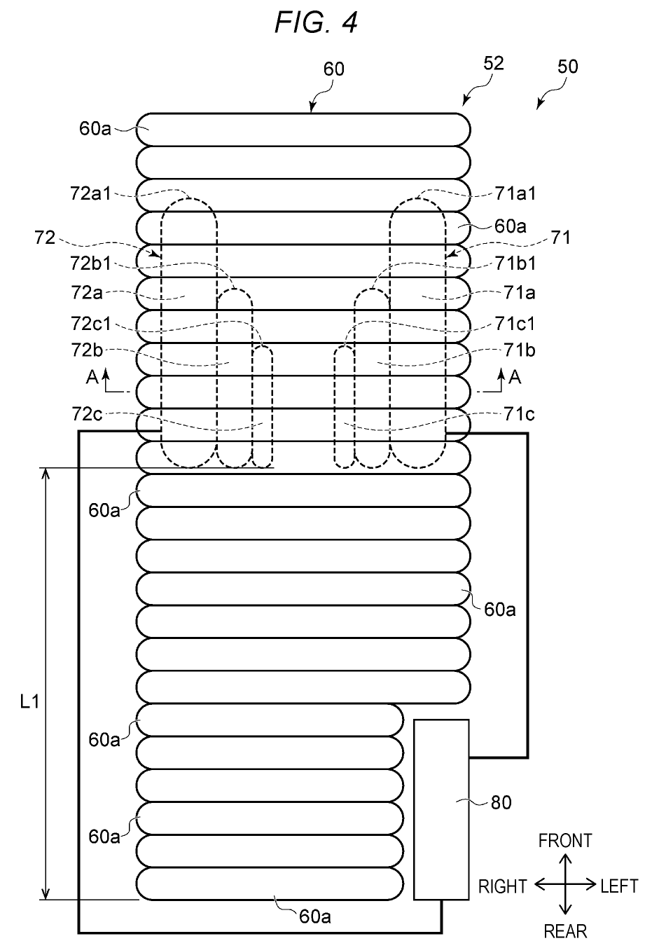

FIG. 4 is a diagram illustrating an air supply/exhaust system of a shoulder part mattress.

The air mattress 50 is provided with the mattress 52 that supports the user H, a mattress controller 83, and a mattress user interface device 85. The mattress 52 is provided with a main mattress 60 that supports a body of the user H, and a shoulder part mattress 70 that is disposed below the main mattress 60.

The main mattress 60 includes a plurality of air cells 60a arranged in the front-and-rear direction. In the main mattress 60, the internal pressure in the plurality of air cells 60a is controlled to allow the mattress 52 to have a preferred hardness of the user H. In the main mattress 60, the internal pressure in the plurality of air cells 60a is controlled to allow the body pressure of the user H to be dispersed.

The shoulder part mattress 70 is disposed below from the shoulder part to the seat part of the user H taking a supine position on the main mattress 60. The shoulder part mattress 70 inflates or deflates, for example, when the back section 23a in the bed 20 is raised and tilted, and is standing. Accordingly, the shoulder part mattress 70 adjusts a position of the user H on the main mattress 60, or changes a body position of the user H.

The shoulder part mattress 70 includes a left shoulder air cell 71 that is disposed on the left side, and a right shoulder air cell 72 that is disposed on the right side. The left shoulder air cell 71 is disposed below a left upper body of the user H taking a supine position. The right shoulder air cell 72 is disposed below a right upper body of the user H taking a supine position. The left shoulder air cell 71 includes a first air cell 71a, a second air cell 71b, and a third air cell 71c. The right shoulder air cell 72 includes a first air cell 72a, a second air cell 72b, and a third air cell 72c.

The shoulder part mattress 70 is disposed on the back section 23a in a state where the mattress 52 is placed above the sections 23 of the bed 20. As illustrated in FIG. 4, a rear end of the shoulder part mattress 70 is disposed so as to have a dimension L1 from a rear end of the main mattress 60 toward a front side (head side), for example. The dimension L1 is, for example, equal to or greater than 1000 mm and equal to or less than 1250 mm.

The rear end of the shoulder part mattress 70 is disposed, for example, within a range from a greater trochanter to the seat part of the user H taking a supine position. In this example, the rear end of the shoulder part mattress 70 may be at the same position in the first to third air cells 71a to 71c and 72a to 72c. However, the rear end of the shoulder part mattress 70 may be different in the first to third air cells 71a to 71c and 72a to 72c in the front-and-rear direction. In the shoulder part mattress 70, air-supply systems of the left shoulder air cell 71 and the right shoulder air cell 72 are different systems. In other words, internal pressure in the left shoulder air cell 71 and internal pressure in the right shoulder air cell 72 are individually controlled.

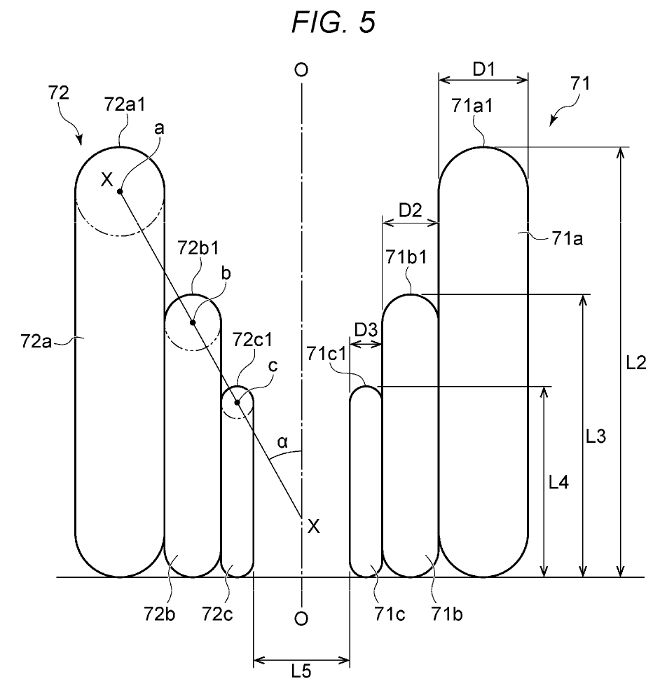

Next, the left shoulder air cell 71 and the right shoulder air cell 72 will be described with reference to FIGS. 5 to 7. The left shoulder air cell 71 and the right shoulder air cell 72 have inversed shapes in the left-and-right direction, and have similar configurations and sizes. In the following description, the left shoulder air cell 71 will be mainly described.

FIG. 5 is a diagram illustrating magnitude, position, and dimension relationships of the shoulder part mattress.

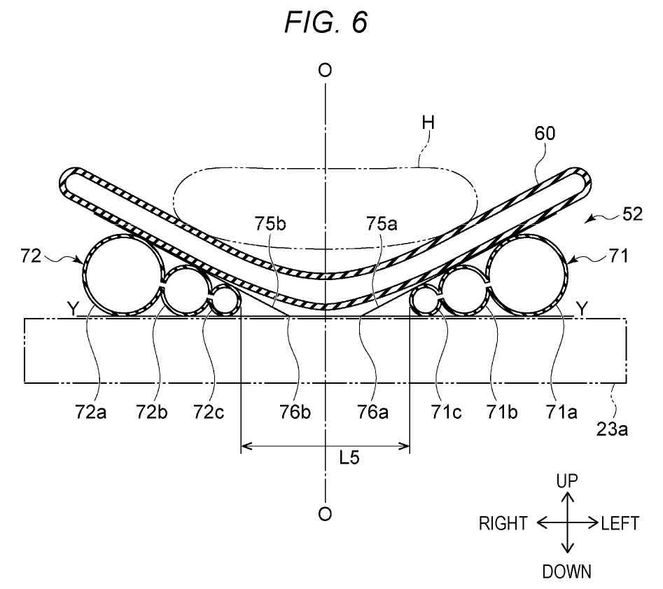

FIG. 6 is a cross-sectional diagram seen from an arrow A-A direction in FIG. 4 in a state where the shoulder part mattress fully inflates.

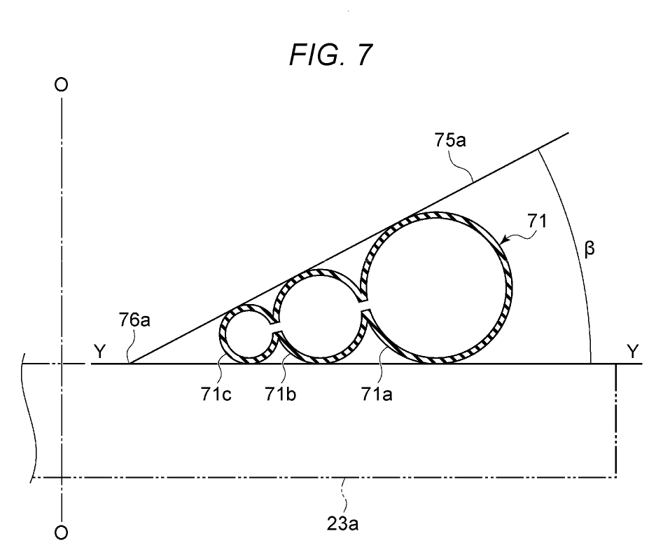

FIG. 7 is a diagram illustrating an inclined angle of the shoulder part mattress.

The left shoulder air cell 71 includes the first air cell 71a that is disposed on an outer side in the left-and-right direction (the lateral direction of the mattress 52), the second air cell 71b that is disposed on an inner side in the left-and-right direction from the first air cell 71a, and the third air cell 71c that is disposed on the inner side in the left-and-right direction from the second air cell 71b. The first air cell 71a is connected to a pump unit 80 via a duct. The inside of the first air cell 71a communicates with the inside of the second air cell 71b. The inside of the second air cell 71b communicates with the inside of the third air cell 71c.

Here, for example, if a front end position of the shoulder part mattress 70 is too close to the head part of the user H, the head part of the user H may be pressed, there is a possibility that the change in the body position of the user H is unable to be effectively performed. The shoulder part mattress 70 is configured so as to lift up with high efficiency a half body of the user H from the position of the center of gravity of the shoulder blade to the vicinity of the seat part, without receiving an influence of the physique of the user H.

As illustrated in FIG. 5, the first air cell 71a to the third air cell 71c have different lengths in the front-and-rear direction. A front end 71b1 of the second air cell 71b is disposed further rear than a front end 71a1 of the first air cell 71a. A front end 71c1 of the third air cell 71c is disposed further rear than the front end 71b1 of the second air cell 71b. In other words, in the left shoulder air cell 71, the front ends 71a1 to 71c1 are formed in a stepped shape.

Specifically, the first air cell 71a to the third air cell 71c are formed to respectively have lengths L2 to L4 corresponding to body heights of a large number of the users H. The shoulder part mattress 70 is configured to be able to correspond to the user H having a body height equal to or higher than 145 cm and equal to or lower than 185 cm, for example.

The first air cell 71a and the second air cell 71b correspond to the user H having a high body height, for example. In this case, the front end 71b1 of the second air cell 71b is disposed between a shoulder part and an ear part of the user H taking a supine position and having a high body height, for example. The first air cell 71a lifts up an arm part of the user H having a high body height.

Meanwhile, the second air cell 71b and the third air cell 71c correspond to the user H having a low body height, for example. In this case, the front end 71c1 of the third air cell 71c is disposed between a shoulder part and an ear part of the user H taking a supine position and having a low body height, for example. The second air cell 71b lifts up an arm part of the user H having a low body height.

The length L2 of the first air cell 71a is set to be equal to or greater than 540 mm and equal to or less than 600 mm, for example. The length L3 of the second air cell 71b is set to be equal to or greater than 390 mm and equal to or less than 400 mm, for example. The length L4 of the third air cell 71c is set to be equal to or greater than 290 mm and equal to or less than 300 mm, for example.

The shoulder part mattress 70 is formed by three spherical bodies of the first air cell 71a to the third air cell 71c. An outer diameter D1 of the first air cell 71a is larger than an outer diameter D2 of the second air cell 71b and an outer diameter D3 of the third air cell 71c. The outer diameter D2 of the second air cell 71b is larger than the outer diameter D3 of the third air cell 71c. In other words, the outer diameter D2 of the second air cell 71b is smaller than the outer diameter D1 of the first air cell 71a and larger than the outer diameter D3 of the third air cell 71c (D1 > D2 > D3).

The outer diameters D1 to D3 of the first air cell 71a to the third air cell 71c are set within a range of equal to or greater than 30 mm and equal to or less than 100 mm, for example. The outer diameter D1 of the first air cell 71a is set to 90 mm, for example. The outer diameter D2 of the second air cell 71b is set to 55 mm, for example. The outer diameter D3 of the third air cell 71c is set to 33 mm, for example.

Next, center positions a to c in the front end of the shoulder part mattress 70 will be described with reference to the right shoulder air cell 72 illustrated in FIG. 5. The center position b of the outer diameter D2 in a front end 72b1 of the second air cell 72b is disposed on a line X-X connecting the center position a of the outer diameter D1 in a front end 72a1 of the first air cell 72a and the center position c of the outer diameter D3 in a front end 72c1 of the third air cell 72c. The center position b in the second air cell 72b may be shifted within about 7 cm in the front direction and within about 7 cm in the rear direction from on the line X-X. An angle α made by the line X-X and a straight line O-O extending in the front-and-rear direction is a value equal to or greater than 24 degrees and equal to or less than 34 degrees, for example.

Next, an inclined plane to be formed in a case where the shoulder part mattress 70 fully inflates will be described with reference to FIGS. 6 and 7.

As illustrated in FIGS. 6 and 7, a lower end of the shoulder part mattress 70 is in contact with the back section 23a. In other words, lower end positions of the first to third air cells 71a to 71c are the same positions in the up-and-down direction. Accordingly, in a case where the shoulder part mattress 70 fully inflates, first and second imaginary lines 75a and 75b each including an inclined plane extending from the outer side toward the inner side in the left-and-right direction (the lateral direction) are formed. The first imaginary line 75a is an inclined plane formed by the left shoulder air cell 71. The second imaginary line 75b is an inclined plane formed by the right shoulder air cell 72.

The first imaginary line 75a is a tangent line of the fully inflated first air cell 71a to third air cell 71c. As illustrated in FIG. 7, an angle β made by the first imaginary line 75a and a horizontal line Y-Y extending in the horizontal direction on the lower end of the left shoulder air cell 71 (the shoulder part mattress 70) is a value equal to or greater than 20 degrees and equal to or less than 30 degrees.

As illustrated in FIGS. 5 and 6, the shoulder part mattress 70 is provided with the left shoulder air cell 71 and the right shoulder air cell 72, which are apart in the left-and-right direction. A dimension L5 in the left-and-right direction between the left shoulder air cell 71 and the right shoulder air cell 72 is a value corresponding to an anterior axillary width of the user H having a small physique, for example. The dimension L5 between the third air cell 71c of the left shoulder air cell 71 and the third air cell 72c of the right shoulder air cell 72 is a value equal to or greater than 200 mm and equal to or less than 300 mm, for example.

Here, for example, in a case where a dimension between the left shoulder air cell 71 and the right shoulder air cell 72 is short in the left-and-right direction, when the shoulder part mattress 70 fully inflates, the main mattress 60 deforms in a V shape. In such a case, there is a possibility that the user H is pressed to be in a narrow state.

As illustrated in FIG. 6, the shoulder part mattress 70 is configured such that the first imaginary line 75a including an inclined plane to be formed when the left shoulder air cell 71 fully inflates does not intersect with the second imaginary line 75b including an inclined plane to be formed when the right shoulder air cell 72 fully inflates.

In other words, the shoulder part mattress 70 is configured such that inclination starting points 76a and 76b that are contacts between the first and second imaginary lines 75a and 75b including inclined planes to be formed when the first to third air cells 71a to 71c and 72a to 72c fully inflate, and the horizontal line Y-Y extending in the horizontal direction at the lower end of the shoulder part mattress 70 are not beyond a center (dot-and-dash line O-O) of the main mattress 60 in the left-and-right direction.

Accordingly, the shoulder part mattress 70 can curve the main mattress 60 in a U shape. The shoulder part mattress 70 can reduce the narrow state of the user H, and can effectively perform the body position change of the user H.

The pump unit 80 is provided to a rear end side of the main mattress 60, for example. The pump unit 80 performs air supply/exhaust to and from the respective air cells 60a in the main mattress 60, the first to third air cells 71a to 71c in the left shoulder air cell 71, and the first to third air cells 72a to 72c in the right shoulder air cell 72 to control the hardness of the main mattress 60 and the shoulder part mattress 70. The pump unit 80 includes a pump 81, a solenoid valve unit 82, and the mattress controller 83.

The pump 81 supplies the air to the main mattress 60 and the shoulder part mattress 70. Specifically, the pump 81 supplies the air via the solenoid valve unit 82 to the respective air cells 60a in the main mattress 60, and the left shoulder air cell 71 and the right shoulder air cell 72 in the shoulder part mattress 70. The pump 81 sucks (forcedly exhausts) the air in the main mattress 60 and the air in the shoulder part mattress 70. The mattress controller 83 controls the actuation of the pump 81.

The solenoid valve unit 82 is disposed between the main mattress 60 and the shoulder part mattress 70, and the pump 81. The solenoid valve unit 82 includes a plurality of solenoid valves corresponding to the air cells 60a and the first air cells 71a and 72a. The solenoid valve unit 82 includes an exhaust valve that exhausts the air in the respective air cells 60a and in the first to third air cells 71a to 71c and 72a to 72c to the outside.

In a case where the pump 81 is positively actuated when the solenoid valves are in an open state, the air from the pump 81 is supplied to the air cells 60a or the first to third air cells 71a to 71c and 72a to 72c. In a case where the pump 81 is stopped when the solenoid valves and the exhaust valve are in an open state, the air in the respective air cells 60a and in the first to third air cells 71a to 71c and 72a to 72c is exhausted. In a case where the pump 81 is reversely actuated when the solenoid valves are in an open state, the air in the air cells 60a or the air in the first to third air cells 71a to 71c and 72a to 72c is sucked. The mattress controller 83 controls the opening and closing operation of the respective solenoid valves and the exhaust valve.

The mattress controller 83 changes the internal pressure in the air cells 60a to control the hardness of the main mattress 60. The mattress controller 83 includes a memory 83a in which a control program for controlling the internal pressure in the air cells 60a is stored.

When the back section 23a in the bed 20 is back-raised, the posture of the user H becomes unstable. The air mattress 50 is provided with the shoulder part mattress 70 that makes a body of the user H stable when the back section 23a is back-raised.

The mattress controller 83 executes body stabilization control processing (body stabilization mode) for stabilizing the body of the user H when the back section 23a is raised and tilted. The mattress controller 83 executes body position change control processing (body position change mode) for changing the body position of the user H when the back section 23a is raised.

In the body stabilization control processing and the body position change control processing, the air is supplied or exhausted to and from the shoulder part mattress 70. Control programs for executing the body stabilization control processing and the body position change control processing are stored in the memory 83a. The mattress controller 83 controls the actuation of the pump 81 and the actuation of the solenoid valve unit 82 to supply the air to the main mattress 60 and the shoulder part mattress 70.

The mattress controller 83 is connected to the mattress user interface device 85, which is described later, and controls the actuation of the pump 81 and the opening and closing operation of the solenoid valve unit 82 based on a command signal from the mattress user interface device 85. For example, a control program based on a command signal from the mattress user interface device 85 is stored in the memory 83a.

The mattress controller 83 acquires a detection value of an air pressure sensor 84 that is provided to a duct connecting the pump 81 and the solenoid valve unit 82 to each other. The air pressure sensor 84 detects the internal pressure in the duct to detect internal pressure in the air cell 60a of the main mattress 60, the internal pressure in the left shoulder air cell 71, and the internal pressure in the right shoulder air cell 72. The mattress controller 83 controls, based on the detection value by the air pressure sensor 84, the actuation of the air pump 81 and the opening and closing operations of the respective solenoid valves in the solenoid valve unit 82.

In this example, the bed controller 39 and the mattress controller 83 have been described as separate controllers but are not limited thereto, and the bed controller 39 and the mattress controller 83 may be configured as one controller.

The mattress user interface device 85 is a remote controller that is operated in order to change the internal pressure in the main mattress 60 and the shoulder part mattress 70. The mattress user interface device 85 is connected to the mattress controller 83 in a wired or wireless manner. The user H and a care giver can change the internal pressure (hardness) in the main mattress 60 and the shoulder part mattress 70 by operating the mattress user interface device 85.

The mattress user interface device 85 includes a body stabilization button 85a that is operated for causing the mattress controller 83 to execute the body stabilization mode, and a body position change button 85b that is operated for causing the mattress controller 83 to execute the body position change mode. The respective operation buttons may be a touch panel or the like. The mattress user interface device 85 may include a display or the like that displays states of the main mattress 60 and the shoulder part mattress 70.

An angle sensor 86 is provided to the main mattress 60. The angle sensor 86 detects a back angle of the main mattress 60 with respect to the horizontal direction. Specifically, the angle sensor 86 detects an inclined angle of a portion in the main mattress 60 to which the shoulder part mattress 70 is disposed with respect to the horizontal direction. A detection value by the angle sensor 86 is transmitted to the mattress controller 83. The angle sensor 86 is provided if necessary.

Next, the body stabilization control processing to be executed in a case where the body stabilization button 85a of the mattress user interface device 85 is operated will be described.

When the back section 23a in the bed 20 is back-raised, the posture of the user H becomes unstable. The air mattress 50 is configured such that the body stabilization mode for stabilizing the body of the user H can be executed when the back section 23a is back-raised.

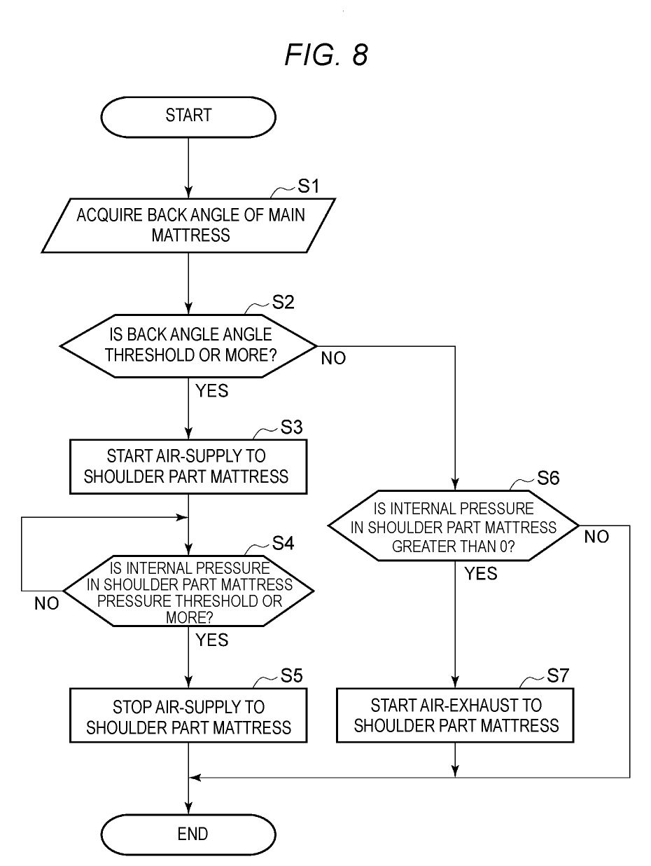

FIG. 8 is a flow diagram illustrating body stabilization control processing that is executed by a mattress controller.

A body stabilization control processing program illustrated in FIG. 8 is stored in the memory 83a, for example. The body stabilization control processing program is repeatedly executed in a predetermined cycle, for example, when an ON operation for the body stabilization button 85a of the mattress user interface device 85 is made, and the body stabilization mode is executed. In FIG. 8, each step is illustrated as "S".

At S1, a back angle of the main mattress 60 is acquired. In other words, the mattress controller 83 acquires a back angle of the main mattress 60 detected by the angle sensor 86. In the main mattress 60, the back section 23a in the bed 20 is back-raised to increase the back angle. The mattress controller 83 may acquire an inclined angle of the back section 23a from the angle sensor 37 of the bed 20, instead of the angle sensor 86 of the air mattress 50.

At S2, whether the back angle is an angle threshold or more is determined. The angle threshold is set to a value equal to or greater than 20 degrees and equal to or less than 35 degrees (for example, 30 degrees), and is stored in the memory 83a. In other words, the mattress controller 83 determines whether the back section 23a in the bed 20 is back-raised at a predetermined angle or more.

If "YES" at S2, in other words, the mattress controller 83 has determined that the back angle is an angle threshold or more, the processing proceeds to S3. On the other hand, if "NO" at S2, in other words, the mattress controller 83 has determined that the back angle is less than the angle threshold, the processing proceeds to S6.

At S3, air-supply to the shoulder part mattress is started. In other words, the mattress controller 83 executes the actuation of the pump 81 and the opening operation of the solenoid valve unit 82 to start the air-supply to the left shoulder air cell 71 and the right shoulder air cell 72.

Next at S4, whether internal pressure in the shoulder part mattress 70 is a pressure threshold or more is determined. In other words, the mattress controller 83 acquires a detection value from the air pressure sensor 84. The pressure threshold is set as pressure when the shoulder part mattress 70 (the left shoulder air cell 71 and the right shoulder air cell 72) fully inflates, for example, and is stored in the memory 83a.

If "YES" at S4, in other words, the mattress controller 83 has determined that the internal pressure in the shoulder part mattress 70 is a pressure threshold or more, the processing proceeds to S5. On the other hand, if "NO" at S4, in other words, the mattress controller 83 has determined that the internal pressure in the shoulder part mattress 70 is less than the pressure threshold, the mattress controller 83 causes the air-supply to the shoulder part mattress 70 to continue, and monitors the internal pressure in the shoulder part mattress 70.

At S5, the air-supply to the shoulder part mattress is stopped. In other words, the mattress controller 83 stops the actuation of the pump 81 and causes the solenoid valve unit 82 to perform the closing operation to stop the air-supply to the left shoulder air cell 71 and the right shoulder air cell 72, and ends the processing.

In this manner, the mattress controller 83 executes the air-supply to the shoulder part mattress 70 if the back angle of the main mattress 60 becomes the angle threshold or more. Accordingly, as illustrated in FIG. 6, the main mattress 60 deforms in the U shape in which the center portion in the left-and-right direction is recessed. In a case where a position of the user H in the left-and-right direction is shifted, the user H can be moved to the center portion in the left-and-right direction. The main mattress 60 has high outer sides in the left-and-right direction. The user H becomes in a state of being wrapped in the left-and-right direction by the main mattress 60, and thus can stabilize the body.

At S6, whether internal pressure in the shoulder part mattress is greater than 0 is determined. In other words, the mattress controller 83 determines whether the left shoulder air cell 71 and the right shoulder air cell 72 inflate if the back angle of the main mattress 60 is less than the angle threshold.

If "YES" at S6, in other words, the mattress controller 83 has determined that the internal pressure in the shoulder part mattress is greater than 0, the processing proceeds to S7. On the other hand, if the mattress controller 83 has determined that the internal pressure in the shoulder part mattress is 0, the processing is ended.

At S7, air-exhaust from the shoulder part mattress is started. In other words, the mattress controller 83 reversely actuates the pump 81 to forcedly exhaust the air in the left shoulder air cell 71 and the air in the right shoulder air cell 72, and ends the processing. The shoulder part mattress 70 is thus deflated in a case where the main mattress 60 is in a horizontal state.

Next, the body position change control processing to be executed in a case where the body position change button 85b of the mattress user interface device 85 is operated will be described.

There is a possibility that a round back posture is promoted and bedsore occurs in the user H when the back section 23a in the bed 20 is back-raised. The air mattress 50 is configured such that the body position change mode for changing the body position of the user H can be executed when the back section 23a is back-raised.

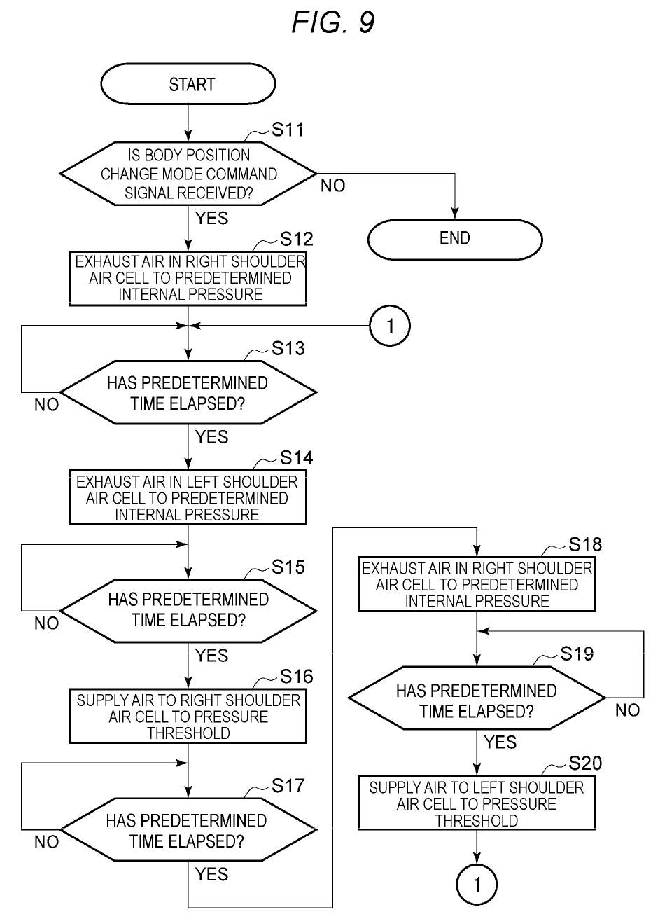

FIG. 9 is a flow diagram illustrating body position change control processing that is executed by the mattress controller.

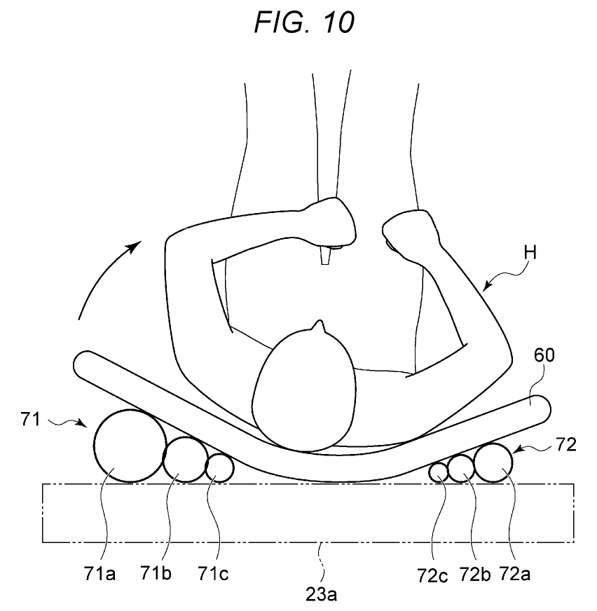

FIG. 10 is a diagram illustrating a state where the body position change control processing has been executed.

A body position change control processing program illustrated in FIG. 9 is stored in the memory 83a, for example. The body position change mode is repeatedly executed in a predetermined cycle, for example, when the back angle of the main mattress 60 is an angle threshold or more, and an ON operation for the body position change button 85b of the mattress user interface device 85 is made. The body position change mode is ended, for example, when the back angle of the main mattress 60 becomes less than the angle threshold or an OFF operation for the body position change button 85b of the mattress user interface device 85 is made. In FIG. 9, each step is illustrated as "S".

At S11, whether a body position change mode command signal is received is determined. In other words, the mattress controller 83 monitors whether the ON operation for the body position change button 85b of the mattress user interface device 85 is made if the back angle of the main mattress 60 is the angle threshold or more and the body stabilization mode is executed.

If "YES" at S11, in other words, the mattress controller 83 has determined that the body position change mode command signal is received, the processing proceeds to S12. On the other hand, if "NO" at S11, in other words, the mattress controller 83 has determined that the body position change mode command signal is not received, the processing is ended.

At S12, the air in the right shoulder air cell is exhausted to predetermined internal pressure. In other words, the mattress controller 83 causes the exhaust valve of the solenoid valve unit 82 to perform an opening operation. The air in the right shoulder air cell 72 is naturally exhausted by the body weight of the user H. The mattress controller 83 deflates the right shoulder air cell 72 until the detection value by the air pressure sensor 84 reaches the predetermined internal pressure. The mattress controller 83 measures elapsed time from when the right shoulder air cell 72 is exhausted to the predetermined internal pressure.

As illustrated in FIG. 10, the left shoulder air cell 71 is in a state where full inflation is maintained, and the right shoulder air cell 72 is in a further deflated state than the left shoulder air cell 71. As a result, in the user H, the right shoulder is lowered, and the body position is changed to the arrow direction in FIG. 10.

Next, at S13, whether predetermined time has elapsed is determined. In other words, the mattress controller 83 determines whether the predetermined time has elapsed from when S12 is executed. The predetermined time is set to equal to or longer than 10 minutes and equal to or shorter than 20 minutes, (for example, 15 minutes), and is stored in the memory 83a. Until the predetermined time elapses, the full inflation of the left shoulder air cell 71 is maintained, and the deflated state of the right shoulder air cell 72 is maintained. If "YES" at S13, in other words, the mattress controller 83 has determined that the predetermined time has elapsed, the processing proceeds to S14. On the other hand, the mattress controller 83 monitors the elapsed time if having determined that the predetermined time does not elapse.

At S14, the air in the left shoulder air cell is exhausted to predetermined internal pressure. In other words, the mattress controller 83 causes the exhaust valve of the solenoid valve unit 82 to perform the open operation to exhaust the air in the left shoulder air cell 71 until the left shoulder air cell 71 becomes the same deflated state as the right shoulder air cell 72. In the user H, this lowers the left shoulder, and the body position is changed to the reverse side of the arrow direction in FIG. 10. The mattress controller 83 measures elapsed time from when the air in the left shoulder air cell 71 is exhausted to the predetermined internal pressure.

Next, at S15, whether predetermined time has elapsed is determined. At S15, the control processing similar to that at S13 is executed. Until the predetermined time elapses, the deflated states in the left shoulder air cell 71 and the right shoulder air cell 72 are maintained. If "YES" at S15, in other words, the mattress controller 83 has determined that the predetermined time has elapsed, the processing proceeds to S16. On the other hand, the mattress controller 83 monitors the elapsed time if having determined that the predetermined time does not elapse.

At S16, the air is supplied to the right shoulder air cell to the pressure threshold. In other words, the mattress controller 83 executes the actuation of the pump 81 and the open operation of the solenoid valve unit 82 to fully inflate the right shoulder air cell 72. This lifts up the right shoulder of the user H, and changes the body position. The mattress controller 83 measures elapsed time from when the air is supplied to the right shoulder air cell 72 to the pressure threshold. At S16, the right shoulder air cell 72 is caused to fully inflate, but does not need to fully inflate, and may inflate to predetermined internal pressure greater than the predetermined internal pressure in the right shoulder air cell 72 at S12.

Next, at S17, whether predetermined time has elapsed is determined. At S17, the control processing similar to that at S13 is executed. Until the predetermined time elapses, the deflated state of the left shoulder air cell 71 is maintained, and the full inflation of the right shoulder air cell 72 is maintained. If "YES" at S17, in other words, the mattress controller 83 has determined that the predetermined time has elapsed, the processing proceeds to S18. On the other hand, the mattress controller 83 monitors the elapsed time if having determined that the predetermined time does not elapse.

At S18, the air in the right shoulder air cell is exhausted to predetermined internal pressure. In other words, the mattress controller 83 causes the exhaust valve of the solenoid valve unit 82 to perform the open operation to exhaust the air in the right shoulder air cell 72 until the right shoulder air cell 72 becomes the same deflated state as the left shoulder air cell 71. This lowers the right shoulder, and the user H becomes the body position (posture) similar to that at S14. The mattress controller 83 measures elapsed time from when the right shoulder air cell 72 is exhausted to the predetermined internal pressure.

Next, at S19, whether predetermined time has elapsed is determined. At S19, the control processing similar to that at S13 is executed. Until the predetermined time elapses, the deflated states in the left shoulder air cell 71 and the right shoulder air cell 72 are maintained. If "YES" at S19, in other words, the mattress controller 83 has determined that the predetermined time has elapsed, the processing proceeds to S20. On the other hand, the mattress controller 83 monitors the elapsed time if having determined that the predetermined time does not elapse.

At S20, the air is supplied to the left shoulder air cell to the pressure threshold. In other words, the mattress controller 83 executes the actuation of the pump 81 and the open operation of the solenoid valve unit 82 to fully inflate the left shoulder air cell 71. This lifts up the left shoulder of the user H, and changes the body position to the arrow direction in FIG. 10. The mattress controller 83 measures elapsed time from when the air is supplied to the left shoulder air cell 71 to the pressure threshold. At S20, the left shoulder air cell 71 is caused to fully inflate, but does not need to fully inflate, and may inflate to predetermined internal pressure greater than the predetermined internal pressure in the left shoulder air cell 71 at S14. After S20 is executed, the processing returns to S13, and the mattress controller 83 monitors predetermined time after S20 is executed.

In this manner, when receiving a body position change mode command signal, the mattress controller 83 inflates one of air cells of the left shoulder air cell 71 and the right shoulder air cell 72 at first internal pressure, and inflates the other air cell at second internal pressure smaller than the first internal pressure. The first internal pressure is set as a pressure threshold when the left shoulder air cell 71 and the right shoulder air cell 72 fully inflate, for example. The second internal pressure is set as predetermined internal pressure in a further deflated state than the full inflation, for example. This can prevent a round back posture of the user H from promoting and bedsore from occurring in the user H when the back section 23a in the bed 20 is back-raised.

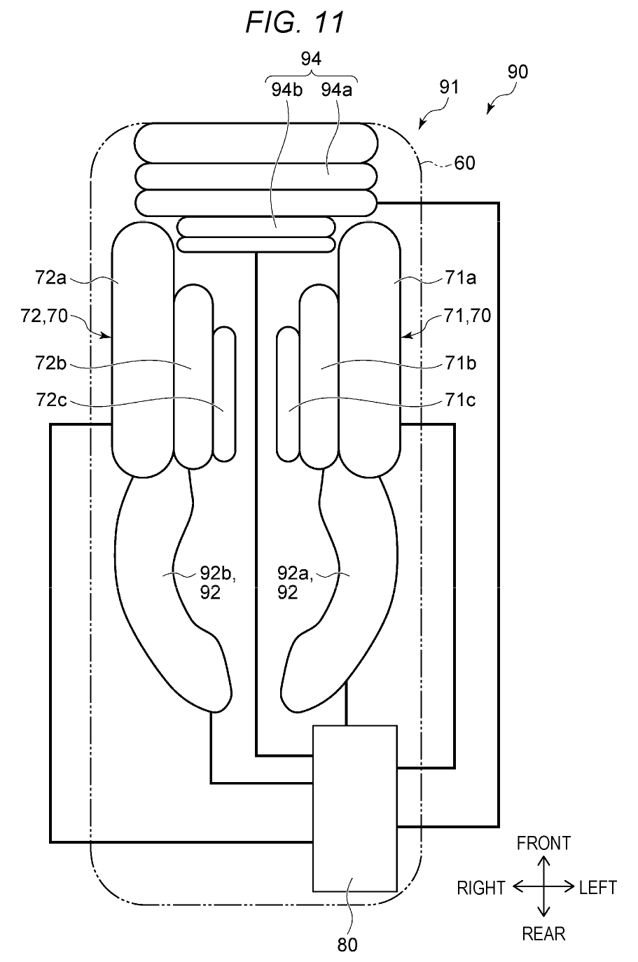

Next, an air mattress 90 according to a second embodiment of the present disclosure will be described with reference to FIG. 11. The air mattress 90 according to the second embodiment is provided with a mattress 91 including, in addition to the shoulder part mattress 70, a buttocks mattress 92, and a head part mattress 94.

FIG. 11 is a plan view illustrating an air mattress according to a second embodiment of the present disclosure.

The buttocks mattress 92 is disposed further rear than the shoulder part mattress 70, and is provided below the main mattress 60. The buttocks mattress 92 is disposed on from the seat section 23b to the upper leg section 23c or the lower leg section 23d, for example, in a state where the mattress 91 is placed above the sections 23 of the bed 20. The buttocks mattress 92 includes a left buttock air cell 92a that is disposed on the left side, and a right buttock air cell 92b that is disposed on the right side.

As illustrated in FIG. 11, the left buttock air cell 92a and the right buttock air cell 92b are formed in curved shapes respectively protruding outward in the left-and-right direction. In a case where the left buttock air cell 92a and the right buttock air cell 92b inflate, a space is formed between the left buttock air cell 92a and the right buttock air cell 92b. The buttocks of the user H are configured to position within the space.

The buttocks mattress 92 has a shape that wraps the buttocks of the user H, and eases an increase in the body pressure around the buttocks, which results in an increase in a bedsore risk, in a case where the back section 23a is back-raised. The buttocks mattress 92 can prevent the user H from shifting to the foot side in a case where the back section 23a is back-raised, and cause the user H to take a stable posture. The buttocks mattress 92 is connected to the pump unit 80 via a duct, and has internal pressure, which is controlled by the mattress controller 83.

The head part mattress 94 is disposed further front than the shoulder part mattress 70, and is provided below the main mattress 60. The head part mattress 94 is disposed on the back section 23a in a state where the mattress 91 is placed above the sections 23 of the bed 20. The head part mattress 94 includes an occipital region air cell 94a that is disposed on a front end side of the main mattress 60, and a chest air cell 94b that is disposed further rear than the occipital region air cell 94a.

The occipital region air cell 94a is disposed below an occipital region of the user H taking a supine position. The occipital region air cell 94a inflates to cause a cervical region of the user H to bend forward. The chest air cell 94b is disposed below a chest of the user H taking a supine position. The chest air cell 94b inflates to push the chest of the user H upward.

The head part mattress 94 has an air cell shape that can further increase an angle by about 20 degrees from an inclined angle of the back section 23a in the bed 20, from the chest over the occipital region of the user H, for example. Accordingly, the head part mattress 94 can easily cause the user H to take a swallowing posture, which is demanded in a meal care cite and the like. The head part mattress 94 is connected to the pump unit 80 via a duct, and has internal pressure, which is controlled by the mattress controller 83.

Next, operations of the shoulder part mattress 70, the buttocks mattress 92, and the head part mattress 94 in a case where the back section 23a in the bed 20 is raised and tilted will be described. Operation control programs for the shoulder part mattress 70, the buttocks mattress 92, and the head part mattress 94 are stored in the memory 83a.

The mattress controller 83 acquires a back angle of the main mattress 60 detected by the angle sensor 86. In the main mattress 60, the back section 23a in the bed 20 is back-raised to increase the back angle. The mattress controller 83 may acquire an inclined angle of the back section 23a from the angle sensor 37 of the bed 20, instead of the angle sensor 86 of the air mattress 50.

When the detection value by the angle sensor 86 has become equal to or greater than an angle threshold, the mattress controller 83 starts the actuation of the pump 81 and causes the solenoid valve unit 82 to be in an open state to start air-supply to the buttocks mattress 92. The angle threshold is set to a value equal to or greater than 20 degrees and equal to or less than 35 degrees (for example, 30 degrees), and is stored in the memory 83a.

The mattress controller 83 continues the air-supply to the buttocks mattress 92 until the air pressure sensor 84 detects the predetermined internal pressure. The predetermined internal pressure is, for example, internal pressure when the buttocks mattress 92 fully inflates.

Accordingly, the buttocks mattress 92 can ease an increase in body pressure around the buttocks, which results in an increase in a bedsore risk, and prevent the user H from shifting to the foot side to cause the user H to take a stable posture.

Next, in a case where the buttocks mattress 92 has inflated to the predetermined internal pressure, the mattress controller 83 switches the solenoid valve unit 82 to start the air-supply to the head part mattress 94. The mattress controller 83 continues the air-supply to the head part mattress 94 until the air pressure sensor 84 detects the predetermined internal pressure. The predetermined internal pressure is, for example, internal pressure when the head part mattress 94 fully inflates. Accordingly, the head part mattress 94 can easily cause the user H to take a swallowing posture, which is demanded in a meal care cite and the like.

Next, in a case where the head part mattress 94 has inflated to the predetermined internal pressure, the mattress controller 83 switches the solenoid valve unit 82 to start the air-supply to the shoulder part mattress 70. The mattress controller 83 continues the air-supply to the shoulder part mattress 70 until the air pressure sensor 84 detects the predetermined internal pressure. The predetermined internal pressure is, for example, internal pressure (pressure threshold) when the shoulder part mattress 70 fully inflates.

In a case where the back section 23a is back-raised, the user H has a high position of the center of gravity, so that a posture of the user H becomes unstable. The shoulder part mattress 70 lifts up outer sides in the lateral direction of the main mattress 60, and thus can make the posture of the user H stable.

In the second embodiment, the case where the buttocks mattress 92, the head part mattress 94, and the shoulder part mattress 70 are caused to inflate in this order has been described as an example. However, the aspect of the present disclosure is not limited thereto, but, for example, the air may be supplied simultaneously to two mattresses, or the air may be supplied simultaneously to three or more mattresses.

The mattress controller 83 maintains the full inflation of the buttocks mattress 92, the head part mattress 94, and the shoulder part mattress 70 until a detection value by the angle sensor 86 becomes less than an angle threshold. In this case, the mattress controller 83 may execute the body position change mode illustrated in FIG. 9 when the ON operation of the body position change button 85b has been made.

The mattress controller 83 starts air-exhaust in the buttocks mattress 92, the head part mattress 94, and the shoulder part mattress 70 having detected that the detection value by the angle sensor 86 is less than the angle threshold. The mattress controller 83 forcedly exhausts the air in the respective mattresses 70, 92, and 94, for example, by reversely operating the pump 81. The mattress controller 83 executes the air-exhaust in the order of the head part mattress 94, the shoulder part mattress 70, and the buttocks mattress 92, for example. The mattress controller 83 may cause the buttocks mattress 92, the head part mattress 94, and the shoulder part mattress 70 to simultaneously exhaust the air.

In the above-mentioned embodiments, the example in which the shoulder part mattress 70 includes the first to third air cells 71a to 71c and 72a to 72c has been described. However, the aspect of the present disclosure is not limited thereto, and for example, the number of the air cells of the shoulder part mattress 70 is not limited to three. For example, the number of the air cells of the shoulder part mattress may be more than three.

### The embodiments may include the following configurations.

### Configuration 1

An air mattress including:

a main mattress that supports a body of a user; and

a shoulder part mattress that is disposed below the main mattress, in which

the shoulder part mattress includes

a first air cell that is disposed on an outer side in a left-and-right direction,

a second air cell that is disposed on a further inner side in the left-and-right direction than the first air cell, and

a third air cell that is disposed on a further inner side in the left-and-right direction than the second air cell,

a front end of the second air cell is disposed further rear than a front end of the first air cell, and

a front end of the third air cell is disposed further rear than the front end of the second air cell.

### Configuration 2

The air mattress according to configuration 1, in which an outer diameter of the second air cell is smaller than an outer diameter of the first air cell and larger than an outer diameter of the third air cell.

### Configuration 3

The air mattress according to configuration 1 or 2, in which the shoulder part mattress includes a left shoulder air cell that is disposed on a left side and a right shoulder air cell that is disposed on a right side.

### Configuration 4

The air mattress according to configuration 3, in which a first imaginary line including an inclined plane formed when the left shoulder air cell inflates does not intersect with a second imaginary line including an inclined plane formed when the right shoulder air cell inflates.

### Configuration 5

The air mattress according to any one of configurations 1 to 4, in which an inclination starting point that is a contact between an imaginary line including an inclined plane to be formed when the first to third air cells fully inflate and a horizontal line extending in a horizontal direction at a lower end of the shoulder part mattress is not beyond a center of the main mattress in the left-and-right direction.

### Configuration 6

The air mattress according to any one of configurations 1 to 5, further including a mattress controller that controls internal pressure in the shoulder part mattress, in which

the mattress controller executes air-supply to the shoulder part mattress when a back angle of the main mattress becomes an angle threshold or more.

### Configuration 7

The air mattress according to any one of configurations 1 to 6:

in which the shoulder part mattress includes

a left shoulder air cell that is disposed on a left side, and

a right shoulder air cell that is disposed on a right side;

further including a mattress controller that controls internal pressure in the shoulder part mattress; and

in which the mattress controller, when receiving a body pressure mode command signal, inflates one of air cells of the left shoulder air cell and the right shoulder air cell at first internal pressure, and inflates the other air cell at second internal pressure smaller than the first internal pressure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An air mattress comprising:
a main mattress that supports a body of a user; and
a shoulder part mattress that is disposed below the main mattress, in which
the shoulder part mattress includes
a first air cell that is disposed on an outer side in a left-and-right direction,
a second air cell that is disposed on a further inner side in the left-and-right direction than the first air cell, and
a third air cell that is disposed on a further inner side in the left-and-right direction than the second air cell,
a front end of the second air cell is disposed further rear than a front end of the first air cell, and
a front end of the third air cell is disposed further rear than the front end of the second air cell.

2. The air mattress according to claim 1, wherein an outer diameter of the second air cell is smaller than an outer diameter of the first air cell and larger than an outer diameter of the third air cell.

3. The air mattress according to claim 1, wherein the shoulder part mattress includes a left shoulder air cell that is disposed on a left side and a right shoulder air cell that is disposed on a right side.

4. The air mattress according to claim 3, wherein a first imaginary line including an inclined plane formed when the left shoulder air cell inflates does not intersect with a second imaginary line including an inclined plane formed when the right shoulder air cell inflates.

5. The air mattress according to claim 1, wherein an inclination starting point that is a contact between an imaginary line including an inclined plane to be formed when the first to third air cells fully inflate and a horizontal line extending in a horizontal direction at a lower end of the shoulder part mattress is not beyond a center of the main mattress in the left-and-right direction.

6. The air mattress according to claim 1, further comprising a mattress controller that controls internal pressure in the shoulder part mattress, wherein
the mattress controller executes air-supply to the shoulder part mattress when a back angle of the main mattress becomes an angle threshold or more.

7. The air mattress according to claim 1, wherein
the shoulder part mattress includes
a left shoulder air cell that is disposed on a left side, and
a right shoulder air cell that is disposed on a right side;
further comprising a mattress controller that controls internal pressure in the shoulder part mattress; and
wherein the mattress controller, when receiving a body pressure mode command signal, inflates one of air cells of the left shoulder air cell and the right shoulder air cell at first internal pressure, and inflates the other air cell at second internal pressure smaller than the first internal pressure.
